(19) United States
(12) Patent Application Publication
(10) Pub. No.: US 2006/0133511 A1
(43) Pub. Date: Jun. 22, 2006

(54) Method to speed up the mode decision of video coding

(76) Inventors: Homer H. Chen, Tai-Chung City (TW); Che-Yu Chang, Nan-Tou City (TW); Chia-Ho Pan, Tai-Nan Hsien (TW)

Correspondence Address: LIN & ASSOCIATES INTELLECTUAL PROPERTY, P.O. BOX 2339, SARATOGA, CA, 95070-0339, US

(21) Appl. No.: 11/209,921

(22) Filed: Aug. 23, 2005

(30) Foreign Application Priority Data
Dec. 16, 2004 (TW) 093139134

(51) Int. Cl. H04N 11/04

(52) U.S. Cl. 375/240.24

(57) ABSTRACT

This invention provides a method to speed up mode decision in video coding standards. It is based on the characteristics of mode distribution and the relationship among the modes of neighboring blocks. It compares the main steps of checking SKIP mode, checking if neighboring blocks have a same mode, checking the best mode, and checking each mode in all inter modes then selecting the best one of these modes. Compared to the H.264 reference software full search method, the simulation result shows that this method can save up to 66.81% of the total encoding time with a slight increase in bit rate and a negligible PSNR drop.

### FIELD OF THE INVENTION

The present invention generally relates to video coding, and more specifically to a method for speeding up the mode decision of video coding.

### BACKGROUND OF THE INVENTION

Video coding has played an important role in multimedia communications and consumer electronics applications. For example, the H.264/AVC (advanced video coding) is the latest international video coding standard jointly developed by the ITU-T Video Coding Experts Group and the ISO/IEC Moving Picture Experts Group (MPEG).

Like previous video coding standards, H.2641AVC uses motion estimation/compensation and intra prediction, respectively, to exploit temporal redundancy between frames and spatial redundancy within each frame. Unlike previous video coding standards, which have a constant block size, H.264 applies variable block sizes in motion compensation, each of which leads to a different inter mode. The size of a block can be 16×16, 16×8, 8×16, 8×8, 8×4, 4×8, or 4×4. It can achieve higher coding efficiency than that of previous standards such as MPEG-4 and H.263. However, it requires a much higher computational complexity due to the use of variable block-size motion estimation, mode decision, intra prediction in P-frame coding, quarter-pixel motion compensation and multiple reference frames.

Besides multiple block types, H.264 supports the use of multiple reference frames (up to five frames). This greatly increases the encoding complexity. If each macroblock (MB) has M modes and N reference frames to choose from, the encoding complexity becomes M×N times higher than the case where there is only one single reference frame and one block type.

To reduce the complexity of H.264, a number of efforts have been made to explore the fast motion estimation, fast intra mode prediction, and fast inter mode prediction. Fast motion estimation is a well-studied topic and is widely applied in the real world. On the other hand, fast mode decision is a new topic in H.264, and no similar work exists in the previous standards.

H.264 specifies seven different block sizes. The size of a block can be 16×16, 16×8, 8×16, or 8×8, and each 8×8 block can be further broken down to sub-macroblocks of size 8×8, 8×4, 4×8, or 4×4, as shown in FIG. 1. For each macroblock of a predictive (P) frame, the encoder provided in the H.264 reference software tries all possible modes in the order: SKIP, 16×16, 16×8, 8×16, 8×8, 8×4, 4×8, 4×4, Intra4×4, and Intra16×16. The SKIP mode represents the case where the block size is 16×16 but no motion or residual information is coded.

Except for SKIP, Intra4×4, and Intra16×16, the decision of each inter mode requires a motion estimation step. The H.264 reference software computes the motion for all inter block types. To achieve the highest coding efficiency, H.264 uses the rate distortion optimization technique to get the best coding result in terms of maximizing coding quality and minimizing resulting data rate.

The mode decision is made by comparing the rate distortion cost of each possible mode, and the mode that has the minimum cost is selected as the best one. The computational load of this mode decision process can be reduced by predicting the best mode and skip the expensive motion estimation step for all remaining candidate modes. There are plenty of methods for speeding up the mode decision process. A common approach is to classify the inter block types into two groups (16×16, 16×8, 8×16) and (8×8, 8×4, 4×8, 4×4). By predicting which group has the best mode, one can omit the motion estimation for the other group. Each method uses its own criterion to predict the best mode.

The method described by P. Yin et al in “Fast mode decision and motion estimation for H.264,” IEEE Int'l Conference on Image Processing, vol. III, pp. 853-856, September 2003, begins with the calculation of the cost of three modes 16×16, 8×8, and 4×4 and checks if the cost tends to monotonically increase (or decrease) with the block size. If there is a monotonic tendency, only the modes (block sizes) between the two best modes are tested. Otherwise, all other modes are tested.

The method described by D. Wu, et al in “Block inter mode decision for fast encoding of H.264,” IEEE Int'l Conference on Speech, Acoustics, and Signal Processing, vol. III, pp. 181-184, May 2004, is based on the observation that homogeneous regions tend to move together and hence should not be split into smaller blocks. The homogeneity of a block is determined by using the amplitude of the edge vector computed by the Sobel operator.

There is no doubt that mode decision plays a very important role in video coding. However, the coding time of a video coding system will be dramatically reduced if the mode decision algorithm can be significantly speeded up.

### SUMMARY OF THE INVENTION

The primary objective of the present invention is to provide a method to speed up the mode decision of video coding. Based on the characteristics of the video content, the present invention speeds up the mode decision of P frames and applies equally well to bidirectionally predicted (B) frames.

The method of the present invention for speeding up the mode decision algorithm comprises the following steps: (a) determine if the best mode of a current macroblock X of a current frame is the SKIP mode by using a threshold T₁, (b) check if the neighboring macroblocks of the current macroblock X have the same mode, (c) determine if the best mode of the current macroblock X is the same mode by using a threshold T₂, (d) check all the inter modes in order and select the best one of them.

According to the present invention, other useful information listed below can be adopted if four neighboring macroblocks of the current macroblock X do not have same mode: three out of four neighboring macroblocks have the same mode or two out of three neighboring macroblocks have the same mode.

Moreover, choosing a correct mode for the first raw or column of a frame is very important. Therefore, this invention checks all the modes of the macroblocks in the first raw or column of a frame, then selects the best mode from them.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows variable block sizes in H.264.

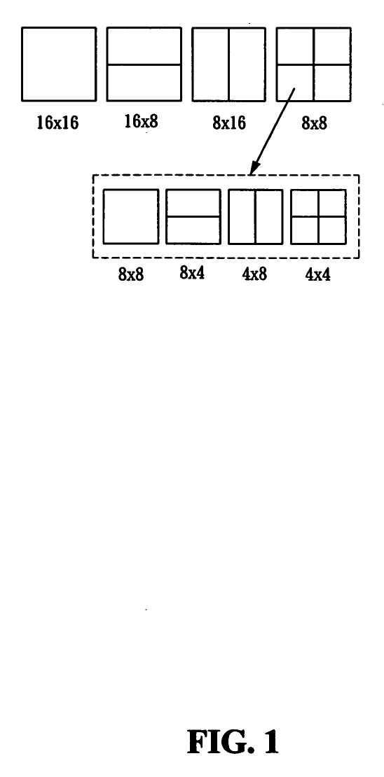

FIG. 2 shows the mode distribution of test sequences.

FIG. 3 shows the current macroblock X and its neighboring macroblocks A, B, and D.

FIG. 4 is the flow chart for determining if the best mode of the current macroblock X is the same as the mode of the block of the prior frame.

FIG. 5 is a main flowchart of a method for speeding up mode decision according to the present invention.

FIG. 6a describes a procedure flow shown in FIG. 5 for deciding if the best mode is SKIP mode.

FIG. 6b describes a procedure flow shown in FIG. 5 for deciding if the best mode is said same mode.

### DETAILED DESCRIPTION OF THE PREFERRED EMBODIMENTS

The method of the present invention for speeding up mode decision is based on two characteristics of the video content. The first characteristic is the relationship between modes and video content. The second characteristic is the relationship that the same modes tend to cluster together. As a general example, these two relationships are further described below using the P frames in the H.264 video coding standard.

When the macroblocks are in the background or smooth regions of the video content, SKIP and 16×16 modes are considered as the best mode. When the macroblocks are in the edge region or fast moving region of the object, the 8×8 mode or the 4×4 mode is considered as the best mode. In other words, the best mode of a macroblock in the background region is SKIP or 16×16 mode. While, 8×8 or 4×4 blocks tend to cluster together to describe the content of the object

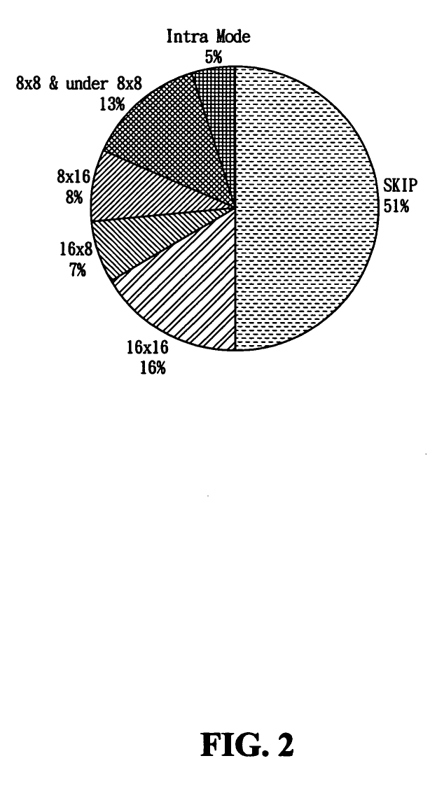

An experiment is run on 8 sequences in both CIF and QCIF size (News, Silent, Coastguard, Container, Foreman, Mobile, Stefan, and Mother & Daughter) for statistical collection to find out the mode distribution of these 8 test sequences. FIG. 2 shows the mode distribution of these 8 test sequences. As can be seen in FIG. 2, SKIP mode occupies 50% share of all macroblocks. This phenomenon means that SKIP mode is a good starting point in the fast mode decision. If the SKIP mode can be found in advance, the processing time in fast mode decision can be saved drastically.

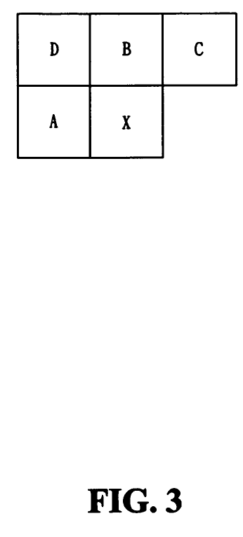

Then, the relations between the current macroblock X and its neighboring macroblocks (including left macroblock A, upper macroblock B, upper-right macroblock C, and upper-left macroblock D) are shown in FIG. 3.

From the results of the analysis, it is interesting to note that the best mode of the current macroblock X can be predicted from the analysis of the spacial relationship among the neighboring macroblocks. This means that the mode of current macroblock X can be assumed in advance to be the same as the relations between macroblocks A, B, C, and D. The higher the probability is, the more efficient the fast mode decision method can be.

The current macroblock X can be assumed in advance to be the same as that of macroblocks A, B, C, and D if the macroblocks A, B, C, and D have the same mode. If the modes of macroblocks A, B, C, and D are not the same, useful information of macroblocks A, B, C, and D can still be adopted: free out of four neighboring macroblocks have the same mode or two out of three neighboring macroblocks have the same mode. Based on the modes of the above neighboring macroblocks, the major mode of the current macroblock X can be guessed because macroblocks with a same mode tend to cluster together. If the correct mode of the current macroblock is hit at once, testing other modes can be skipped to save computation time.

According to the present invention, two thresholds T₁ and T₂ are set to decide whether the predicted mode of the current macroblock is acceptable or not T₁ is the average rate-distortion cost of all coded macroblocks in SKIP mode, T₂ is the average rate-distortion cost of main macroblocks of current macroblock. The main macroblocks are the four or three of the four neighboring macroblocks A, B, C, and D, or the three or two of the three neighboring macroblocks A, B, and D. According to the present invention, the values of the thresholds T₁ and T₂ can be dynamically adjusted or, for example, they can be other information related to the modes of neighboring blocks.

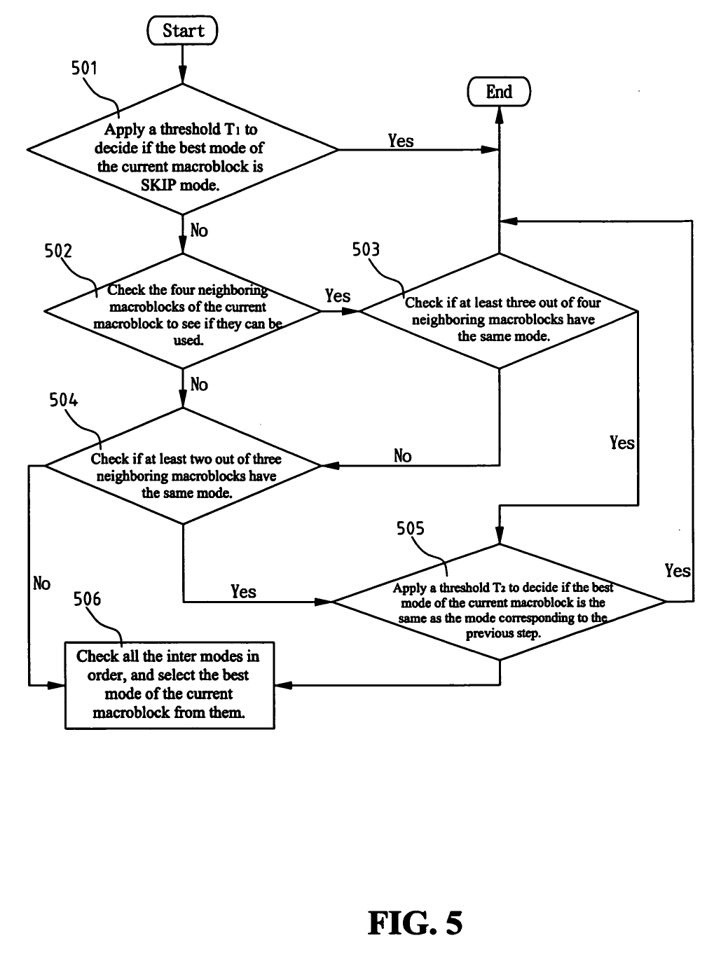

The fast mode decision method of the present invention is shown in FIG. 5. In the method, it first applies a threshold T₁ to decide if the best mode of the current macroblock is SKIP mode, as shown at step 501. The decision flow of the method is stopped if the current macroblock is SKIP mode. Otherwise, it goes on to step 502. At step 502, the method checks the four neighboring macroblocks of the current macroblock, including left macroblock A, upper macroblock B, upper-right macroblock C, and upper-left macroblock D, to see if they can be used. If the four neighboring macroblocks can be used, the method checks if at least three out of four neighboring macroblocks have the same mode, as shown at step 503. Otherwise, it goes to step 504. At step 504, the method checks if at least two out of three neighboring macroblocks have the same mode. If at least three out of four neighboring macroblocks have the same mode, or at least two out of three neighboring macroblocks have the same mode, the method applies a threshold T₂ to decide if the best mode of the current macroblock is the same as the mode corresponding to the previous step, as shown at step 505. If no two or three out of three neighboring macroblocks have the same mode, or no three or four out of four neighboring macroblocks have the same mode, the method checks all the inter modes in order, and selects the best mode of the current macroblock from them, as shown at step 506. According to H.264 video coding standard, all the inter modes are in sequence of {16×16, 16×8, 8×16, 8×8, 8×4, 4×8, 4×4}.

The accuracy of mode decision in the first raw or column of a frame is very important for predicting current mode from four neighboring macroblocks A, B, C, and D. Therefore, the method checks all the modes of the macroblocks in the first raw or column of a frame prior to step 501, and selects the best mode from them.

The adoption of step 506 is to refine the result if early termination criteria for a mode decision all fail. It is worth mentioning that Intra4×4 and Intra16×16 are not checked at step 506.

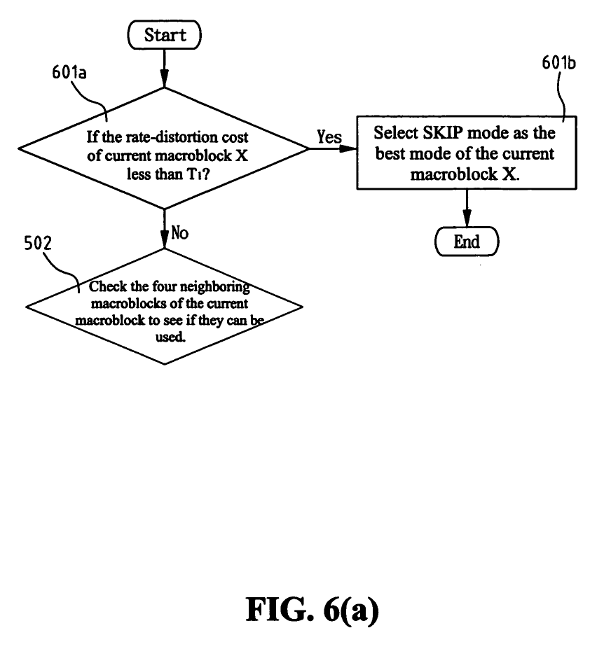

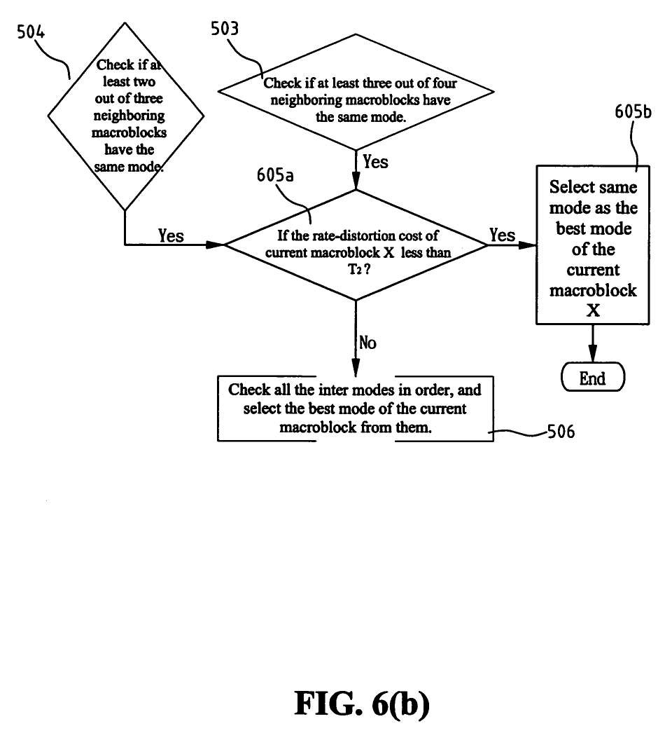

On the other hand, at steps 501 and 505, the method of the invention sets two thresholds T₁ and T₂ to decide whether the predicted mode of the current macroblock is acceptable or not. T₁ is set to be the average rate-distortion cost of all coded macroblocks in SKIP mode. And, step 501 comprises two substeps shown in FIG. 6a. At substep 601a, the method checks if the rate-distortion cost of current macroblock X is less than T₁. If the rate-distortion cost is less than T₁, the method selects SKIP mode as the best mode of the current macroblock X, as shown at substep 601b. Otherwise, it goes on to step 502 shown in FIG. 5.

Similarly, T₂ is set to be the average rate-distortion cost of all neighboring macroblocks having the same mode according to the present invention. And, step 505 comprises two substeps shown in FIG. 6b. At substep 605a, the method of the invention checks if the rate-distortion cost of current macroblock X is less than T₂. If the rate-distortion cost is less than T₂, the method selects same mode as the best mode of the current macroblock X, as shown at substep 605b. Otherwise, it goes on to step 506 shown in FIG. 5.

Besides, another threshold T₃ can be set according to the present invention. T₃ is set to be the average rate-distortion cost of the corresponding blocks at same location as current block and located at one or more previous frames. Alternatively, T₃ can be set to be the sum of two average rate distortion costs, The first average rate distortion cost is the average rate-distortion cost of the corresponding blocks at same location as said current block and located in one or more previous frames. The second average rate-distortion cost is the average rate-distortion cost of the macroblocks which are located at one or more previous frames and each frame comprises at least three coded neighboring macroblocks.

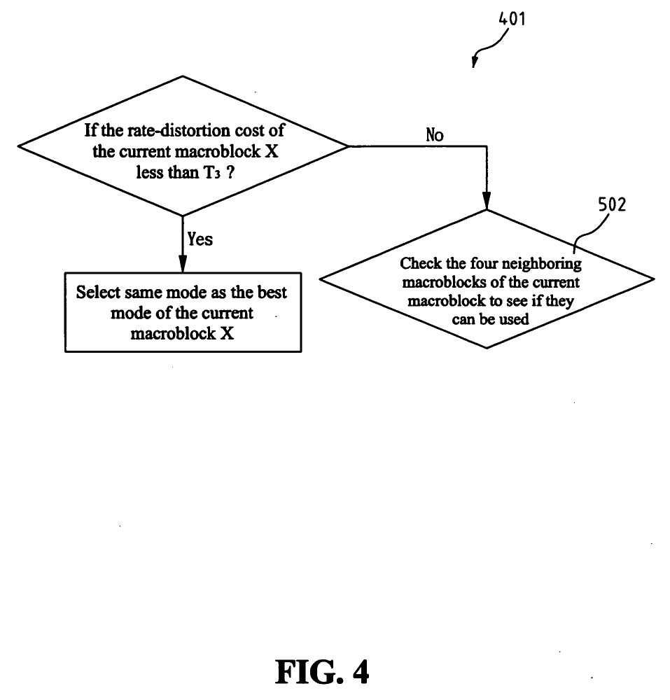

According to the present invention, the value of the threshold T₃ can be dynamically adjusted or, for example, it can be other information related to the modes of neighboring blocks. Prior to step 502, one more step of applying threshold T₃ can therefore be added to decide if the best mode of current macroblock X is the same as the mode of a macroblock located at one or more previous frames. As shown at step 401 of FIG. 4, the method of the invention checks if the rate-distortion cost of current macroblock X is less than T₃. If the rate-distortion cost is less than T₃, the method selects same mode as the best mode of the current macroblock X. Otherwise, it goes to step 502 shown in FIG. 5.

In summary, the present invention provides a fast mode decision method. The fast mode decision method is based on the characteristics of mode distribution and the relationship between the modes of neighboring blocks and the related reference modes of early frames. The invention needs not extra computation to predict the best mode as compared to a full research method of the video coding standard reference software. The invention greatly reduces the encoding time. The PSNR remains about the same although the bit rate increases slightly.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for speeding up the mode decision of video coding, every macroblock of every frame in said video coding corresponds to a mode, said mode is chosen from the group of SKIP mode, inter mode, and intra mode, said method comprises the steps of:
(a) determining if the best mode of a current macroblock X of a current frame is the SKIP mode by using a threshold T₁, and stopping here if the answer is yes;
(b) checking if the neighboring macroblocks of said current macroblock X have the same mode, and going to step (d) if the answer is no;
(c) determining if the best mode of said current macroblock X is said same mode by using a threshold T₂, and stopping here if the answer is yes; and
(d) checking all the inter modes in order and selecting the best mode of said current macroblock X from them.

2. The method for speeding up the mode decision of video coding as claimed in claim 1, wherein said step (b) further comprises the steps of:
(b1) checking if four neighboring macroblocks of said current macroblock X are available for use, and going to step (b3) if the answer is no;
(b2) checking if at least three out of said four neighboring macroblocks have the same mode, and going to step (c) if the answer is yes; and
(b3) checking if at least two out of three neighboring macroblocks of said current macroblock X have the same mode, and going to step (d) if the answer is no.

3. The method for speeding up the mode decision of video coding as claimed in claim 1, wherein said video coding complies with the H.264 video coding standard.

4. The method for speeding up the mode decision of video coding as claimed in claim 1, wherein said threshold T₁ is dynamically adjusted.

5. The method for speeding up the mode decision of video coding as claimed in claim 1, wherein said threshold T₂ is dynamically adjusted.

6. The method for speeding up the mode decision of video coding as claimed in claim 1, wherein said threshold T₁ is set to be the average rate-distortion cost of all coded macroblocks in SKIP mode.

7. The method for speeding up the mode decision of video coding as claimed in claim 1, wherein said threshold T₂ is set to be the average rate-distortion cost of corresponding neighboring macroblocks of said current block, and said corresponding neighboring macroblocks have the same mode.

8. The method for speeding up the mode decision of video coding as claimed in claim 1, wherein the following step is performed prior to said step (a):
checking all the modes of the macroblocks in the first raw or column of a frame, and selecting the best mode from them.

9. The method for speeding up the mode decision of video coding as claimed in claim 1, wherein said step (a) further comprises the steps of:
(a1) checking if the rate-distortion cost of said current macroblock X is less than T₁; and
(a2) if the answer being yes, selecting said SKIP mode as the best mode of said current macroblock X, otherwise going to step (b).

10. The method for speeding up the mode decision of video coding as claimed in claim 1, wherein said step (c) further comprises the steps of:
(c1) checking if the rate-distortion cost of said current macroblock X is less than T₂; and
(c2) if the answer being yes, selecting said same mode as the best mode of said current macroblock X, otherwise going on to step (d)

11. The method for speeding up the mode decision of video coding as claimed in claim 1, wherein said SKIP mode represents that said corresponding macroblock has no motion and no residual information is coded.

12. The method for speeding up the mode decision of video coding as claimed in claim 1, wherein said four neighboring macroblocks include left macroblock, upper macroblock, upper-right macroblock, and upper-left macroblock.

13. The method for speeding up the mode decision of video coding as claimed in claim 1, wherein said best mode at step (d) is the mode with the minimum rate-distortion cost.

14. The method for speeding up the mode decision of video coding as claimed in claim 1, wherein the following step is performed prior to said step (b):
applying a threshold T₃ to determine if the best mode of said current macroblock X is the same as the mode of the macroblocks located in one or more previous frames, and checking if the rate-distortion cost of said current macroblock X is less than T₃, selecting said same mode as the best mode of said current macroblock X and stopping said mode decision if the answer is yes, otherwise, going on to step (b).

15. The method for speeding up the mode decision of video coding as claimed in claim 14, wherein said threshold T₃ is set to be the average rate-distortion cost of the corresponding blocks at same location as said current block and located in one or more previous frames.

16. The method for speeding up the mode decision of video coding as claimed in claim 14, wherein said threshold T₃ is set to be the sum of a first and a second average rate distortion costs, said first average rate distortion cost is the average rate-distortion cost of the corresponding blocks at same location as said current block and located in one or more previous frames, and said second average rate-distortion cost is the average rate-distortion cost of the macroblocks which are located at one or more previous frames and each frame comprises at least three coded neighboring macroblocks.

17. The method for speeding up the mode decision of video coding as claimed in claim 14, wherein said threshold T₃ is dynamically adjusted.
